(19) United States
(12) Patent Application Publication
(10) Pub. No.: US 2013/0062909 A1
(43) Pub. Date: Mar. 14, 2013

(54) MULTIFUNCTIONAL FLATBED SYSTEM FOR ALL-TERRAIN VEHICLES

(71) Applicants: Chris B. Harris, Amity, OR (US); Terry Lee Wilmeth, (US)

(72) Inventors: Chris B. Harris, Amity, OR (US); Terry Lee Wilmeth, (US)

(21) Appl. No.: 13/607,686

(22) Filed: Sep. 8, 2012

Related U.S. Application Data
(60) Provisional application No. 61/532,626, filed on Sep. 9, 2011.

(51) Int. Cl. B62D 33/023; B62D 33/02

(52) U.S. Cl. 296/182.1; 296/19

(57) ABSTRACT

A multifunctional inventive flatbed system is described for all-terrain vehicles (ATVs), and in particular light tactical all-terrain vehicles (LTATVs) for special operations units of the military, where the flatbed system is specially adapted for improved transport of patients in litters, personnel and cargo on such vehicles.

### CROSS REFERENCE TO RELATED APPLICATIONS

This application claims benefit of U.S. Provisional Application No. 61/532,626 filed on Sep. 9, 2011.

### FIELD OF INVENTION

This invention relates to a flat-bed mount for all terrain vehicles employed in both civilian and military use, wherein a an all terrain vehicle can be provided with a rear flat bed platform for rapid and facile field conversion of the vehicle to accommodate a variety of utilities, such as a temporary ambulance for transportation of casualties, provision of rear-facing seating, and provision of rails for mounting weaponry.

### BACKGROUND

The art is replete with examples of medical evacuation systems for field use in military and civilian applications. Many examples are directed to airlift situations, where systems are devised for transporting patients in stretchers or NATO-style litters in helicopters or fixed-wing aircraft. These examples include the following patent citations:

U.S. Pat. No. 4,178,032 to Hone, which discloses a litter carrying apparatus for use in air ambulances or helicopters; U.S. Pat. No. 4,397,432 to Resetar, wherein an adjustable litter support assembly for aircraft is disclosed, using stanchions fittings with litter support arms that can be moved up or down to accommodate patients on litters. U.S. Pat. No. 4,783,025 to Moffett, which discloses movable pallet for movably supporting a patient in an emergency medical setup in a helicopter. U.S. Pat. No. 5,383,629 to Morgan discloses a mufti-tiered litter rack system designed for disposition on walls in a helicopter or a fixed wing aircraft; U.S. Pat. No. 5,738,306 to Moss et al., disclosing a tiltable litter receiving table loading and transporting patients in helicopters and fixed wing aircraft, while at the same time providing a table for emergency patient care.

For ground and/or air vehicles, examples of litter mounting and carrying apparatuses are disclosed in the following citations:

U.S. Pat. No. 6,923,606 to Fehrle et al., disclosing a reconfigurable patient support pallet system for transporting patients on NATO-style litters and/or airline-style or other seats, in response to the problems of existing patient evacuation systems, and to meet the need for a patient evacuation system for use in a variety of modes of transportation. The pallet system includes a pallet mounted to the floor of a vehicle. The pallet comprises a plurality of track rails and attachment points for attaching a litter stanchion set, and/or attaching seats to the pallet. U.S. Pat. No. 7,328,926 to Myers et al., disclosing a litter support system adapted for attachment to the chassis of a vehicle with a cargo bed, such as found in an ambulance. The apparatus is designed to receive and lock NATO-style litters on a rack system, and allow lateral movement of the secured litter from the wall of the cargo area towards the middle of the cargo area to facilitate loading of the litters onto the racks, and emergency patient care en-route by an attendant; U.S. Pat. No. 7,883,133 to Chinn, disclosing a wall-attachable litter rack system holding upper and lower litter supports for vehicles for loading and transporting NATO-style litters, where litter supports are rotatable for storage and deployment, and horizontally movable for patient treatment.

In recent years, Special Operations units of the U.S. Army have adapted the use of all-terrain vehicles (ATVs) for tactical deployment of soldiers over open terrain. ATVs that are adapted for military operations are referred to a lightweight tactical all terrain vehicles (LTATVs). An example of a current commercial LTATV is the Ranger RZR SW built by Polaris Defense, a subsidiary of Polaris Industries Inc. LTATV, and the Strike Razor LTATV built jointly by RP Advanced Mobile Systems and Polaris Defense. Early generations of LTATVs have been designed for rapid and agile deployment in open terrain, with minimal attention given to surperfluous or auxiliary functions such as transporting cargo and evacuating casualties. As the versatility of the LTATV is expanded, the latter consideration has been given elevated status. Presently the LTATV can accept a stretcher or emergency litter, such as a NATO-style litter on a specially adapted litter rack mounted on the rear cargo deck only by placing the litter sideways, that is, with the long axis of the litter perpendicular to that of the vehicle. This configuration forces the ends of the litter hold the patient's head and feet to protrude from the sides of the LTATV. Such a configuration clearly is disadvantageous and poses unwarranted dangers for both the patient and to both the personnel attending to the patient, and to those driving and defending the vehicles and its riders.

Similar considerations apply to civilian patient evacuation applications, such as for search and rescue operations. ATVs are frequently used in such operations, and transportation of litters out of a wilderness area using an ATV requires use of unsatisfactory litter racks that produce the same conditions as described above.

### SUMMARY

To this end, improvement in the current attributes related to patient evacuation have been developed by the instant inventors, resulting in a highly practical and efficient design of a ATV flatbed system for transformation of the rear cargo deck of the ATV or LTATV into a multifunctional patient evacuation system, personnel and cargo transporting extension of the ATV/LTATV.

The invention comprises a multifunctional flatbed mount for modification of a standard LTATV or ATV, but can also be used on other small utility vehicles. The invention will hereafter be referred to as the inventive flatbed system. In all of the embodiments described herein, the inventive flatbed system is designed to fit over the rear engine bay of standard ATVs and LTATVs in order to provide a mounting platform fulfilling several functions. In a first aspect of the preferred embodiment of the invention, the inventive flatbed is equipped with a track rail and slideable bracket mounting system to mount and secure NATO-style stretchers or litters in the field for transportation of casualties. The inventive flatbed system is configured so that the litters are oriented with their long axis is parallel with that of the vehicle, an improvement over previous litter racks whereby the litters are oriented perpendicular to the direction of travel, forcing the head and feet of the patient to protrude out of the sides of the vehicle. In a second aspect of the preferred embodiment of the invention, the inventive flatbed system comprises hitch mounts for rapid attachment of one or two rear-facing quick mount/dismount seats for carrying a medical attendant or additional personnel. In a third aspect of the preferred embodiment of the invention, the inventive flatbed comprises tie-down rails for securing cargo or objects using various means. The inventive flatbed comprises several articulating members.

The preferred embodiment of the inventive flatbed further comprises a hinged tailgate fence that can fold down from a vertical closed position to a horizontal open position in order to accommodate litters or oversized cargo, in addition to extending from the aft portion of the flatbed platform while in the open position to provide extra length and support. The tailgate provides an aft mounting means for accommodating a track rail litter mount. In the horizontal position, the aft track rail is collocated vertically with the forward track rail mounted on the front of the inventive flatbed, so that mounted litters will be substantially parallel with the flatbed.

The preferred embodiment of the inventive flatbed platform provides hitch posts or studs for accepting quick mount/dismount rear-facing seats for accommodating additional personnel, namely an attendant to sit at the side of a transported patient, additional rearward-facing defenders. Up to two sears can be accommodated at a time, with three seat posts available for hitching or mounting the seats.

The preferred embodiment of the inventive flatbed platform provides slots disposed at strategic locations for insertion of tie-down rails for anchoring stud-rings and the like, providing anchor points for strapping in cargo. Said slots are disposed over sunken tracks or grooves machined into the sub-frame cross-rails wherein threaded bolt holes are provided to fit and secure the tie-down rails in such a way that the top of the tie-down rails are flush with the surface of the flatbed platform.

The preferred embodiment of the inventive flatbed comprises a backend plate that is integral with the flatbed platform, wherein cutouts are provided to fit over the tail light housings so that the tail light can be seen. Tail light caps having the same shape as the tail light housings are provided that are affixed to the aft side rail of the flatbed frame, and fit over the tail light housings, whereby the tail lights are recessed within the caps, in this way the caps protect same from potential damage due to use of the flatbed.

The preferred embodiment of the inventive flatbed further comprises a heat cover that bolts to the underside of the flatbed sub-frame, for the purpose of deflecting heat emanating from the engine, as the latter is mounted in the rear of a typical ATV.

### BRIEF DESCRIPTION OF THE DRAWINGS

FIG. 1. Contextual view of the inventive flatbed system mounted on a LTATV showing the partial view of the frame of the vehicle for simplicity.

FIG. 2a. Exploded view of components of the inventive flatbed system

FIG. 2b. Assembled view of the inventive flatbed system, without rear heat pads.

FIG. 2c. Assembled view of the inventive flatbed system, showing rear seat pads.

FIG. 3. Rear view of the sheet metal bed component of the inventive flatbed system.

FIG. 4a. Trimetric view of the base frame from the front.

FIG. 4b. Rear-view of the base frame showing taillight wells.

FIG. 4c. Underside view of the aft frame of the vehicle supporting the base frame of the inventive flatbed system, showing the non-rectangular nature of the vehicle frame and portions of the base frame not supported.

FIG. 5. View of the inventive flatbed system mounted on the frame of the ATV showing the side support bars for mitigation of cantilever of the unsupported portions of the base frame.

FIG. 6a. Isometric view of the ATV frame including the inventive flatbed system, with NATO litters mounted on the flatbed.

FIG. 6b. View of inventive flatbed system with litters lifted up and away to expose the litter mounting assembly.

FIG. 6c. Side view of the inventive flatbed system showing that the horizontal orientation of a mounted NATO litter is ensured due to the design of the tailgate.

FIG. 6d. Elaboration of view in FIG. 6c, with side view of the ATV frame included to show contextual relationship of mounted litter with the vehicle.

FIG. 7a. Detailed view of tailgate, showing mounting plates for track rail component of the litter mounting assembly.

FIG. 7b. Same view as in FIG. 7a, including rear portion of the litter mounting assembly (track rail and litter catch brackets).

FIG. 8a. Details of litter mounting assembly, showing individual components in exploded view.

FIG. 8b. View of assembled components shown in FIG. 8a.

### DETAILED DESCRIPTION

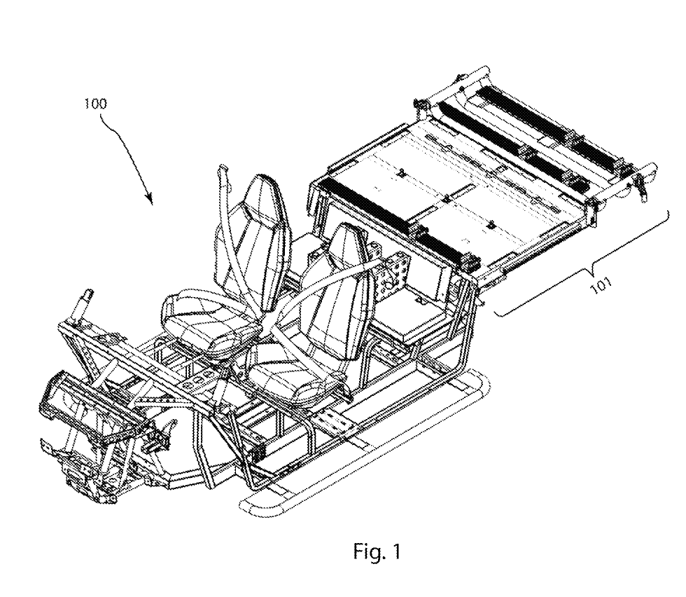

The invention will now be described in detail. The preferred embodiment of the invention comprises a mountable multifunctional flatbed designed to fit over the engine bay on the rear end of small all-terrain vehicles (ATVs) that are not so equipped. This is shown in FIG. 1, where the bare frame of an ATV 100 is shown with the inventive flatbed system 101 extending from the rear of the vehicle.

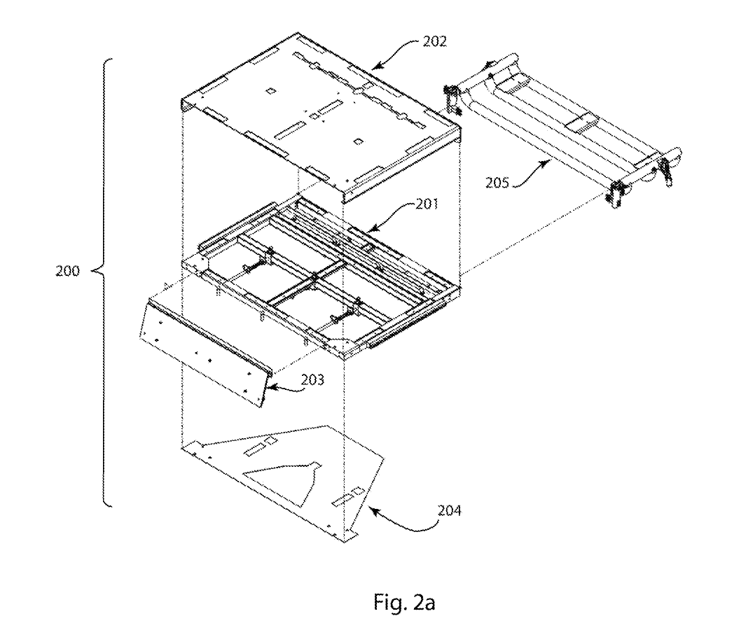

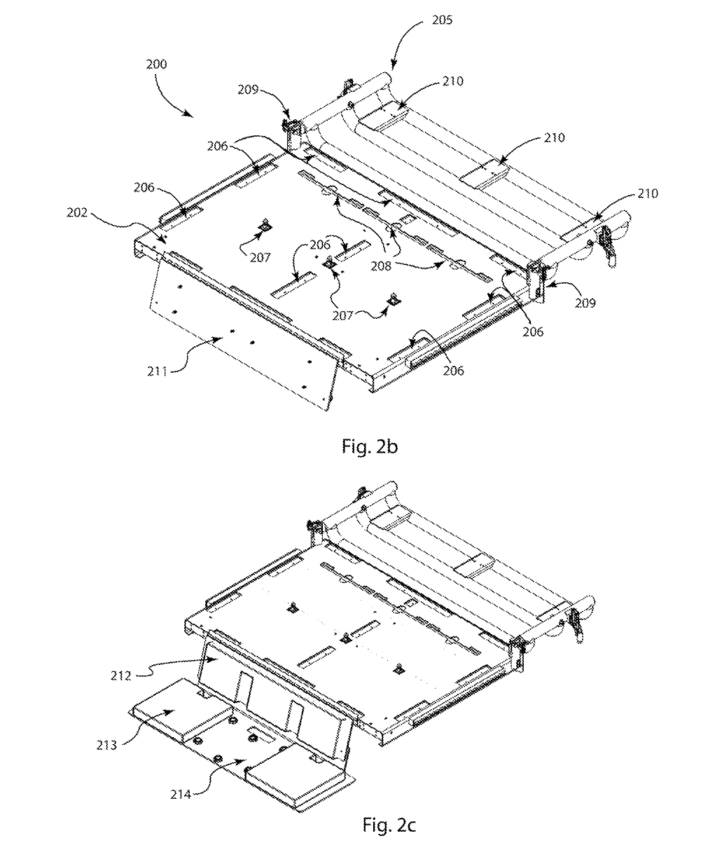

The inventive flatbed system for ATVs comprises several sections. These, along with their spatial relationship to one another, are shown in FIG. 2a, which depicts an exploded overview of the flatbed system. Referring to FIG. 2a, the preferred embodiment of the inventive flatbed system 200 comprises a base frame section 201 that is bolted to the vehicle frame and provides the principle structural support for the system; a sheet metal bed section 202 that lays over and fastened to the base frame 201; a backing plate section 203 intended for support of backrest pads that form part of a rear seating bench, hingeably attached to the front, or forward portion of the flatbed system; a heat shield section 204 juxtaposed below and fastened to base frame 201, provided to deflect engine heat in order to protect personnel or cargo resting on the flatbed; a tailgate section 205 that is hingeably or otherwise pivotally attached to the rear, or aft portion of the inventive flatbed system, that in addition to providing a normal tailgate function, provides attachment structure for a litter mounting means (not shown) for mounting and securing medical litters for transportation, a principle purpose for the inventive flatbed system.

A view of the fully assembled preferred embodiment of the inventive flatbed system is shown in FIG. 2b. Further details will be now be described. Continuing with the nomenclature introduced above in the description of FIG. 2a, sheet metal bed 202 overlays and is in intimate contact with base frame 201 (not visible), which itself is attached by means of bolts or other appropriate fasteners to the vehicle frame forming the engine bay on the rear end of an ATV. Sheet metal bed 202 comprises cutouts 206 intended to accommodate tie-down rail inserts and/or track rails (to be bolted to base frame below the bed) are disposed at strategic locations at the periphery and center of bed 201. Further accessorizing bed 202 are hitch posts 207 and slots 208 for the positioning and securing of removable seats. Tailgate 205 is pivotally affixed to the rear edge of the bed via hinge assemblies 209. Tailgate section 205 is further adorned with mounting plates 210 positioned between the horizontal rails for the purpose of accommodating a mounting apparatus for securing and transporting emergency litters.

When tailgate 205 is in the open position, the flatbed system will accommodate medical litters or stretchers for carrying casualties. A litter kit assembly comprising two track rails 206 and at least four litter catches 207 that are slideably carried on track rails 206, can be mounted on the bed portion 201 and the tailgate portion 205 of flatbed system 200. The litter kit assembly is configured so that the mounted litters are oriented with their long axis parallel to the direction of travel.

The inventive flatbed further comprises a means to provide additional rear seating in the personnel compartment of the ATV. To this end, a plate 211 is hingeably attached to the front portion of bed 201. As shown in FIG. 2c, Plate 211 provides support for backrest pads 212 making the dossier three rear seats 213 on support plate 214 disposed behind the front or rear stock bucket seats of the ATV in order to accommodate seating for additional passengers beyond two or four for which the vehicle was intended to accommodate in the vehicle.

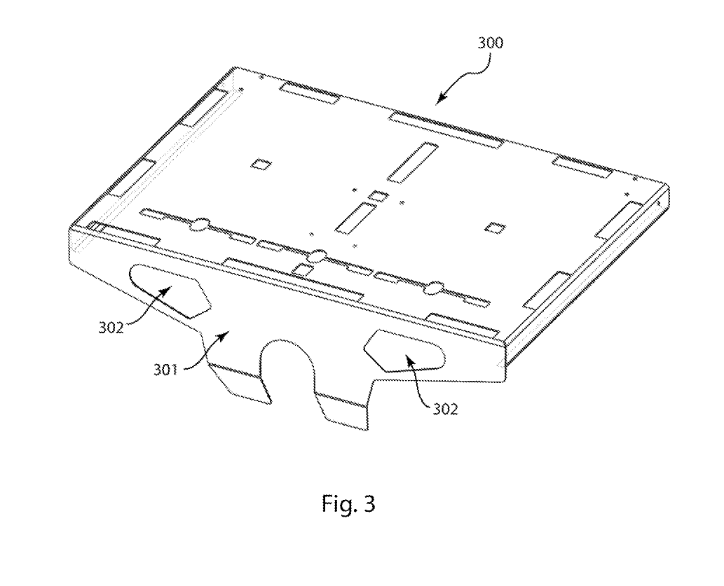

FIG. 3 details the rear view of the bed section, which further comprises a rear shield 301 that is integral with the flat portion 300 of the bed, wherein the shield is formed by bending a portion of the pre-formed sheet metal. The particular shape of the rear shield is arbitrary, and may conform to particular aspects of the design of the rear portion of the vehicle. Cutouts 302 are provided to fit over the vehicle taillights. The particular shape of cutouts 302 are completely geared to the shape of the taillight caps of the vehicle.

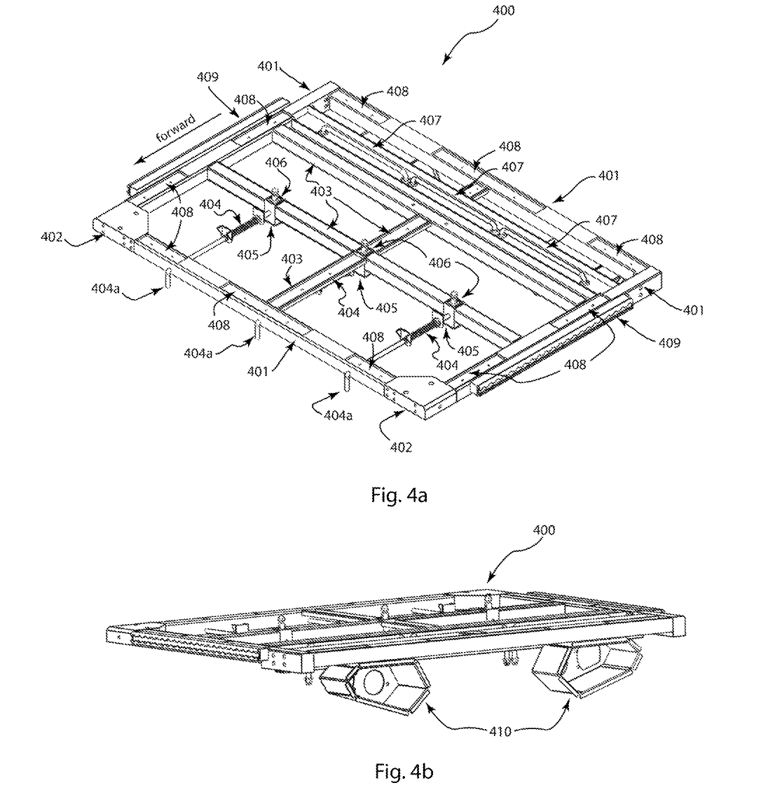

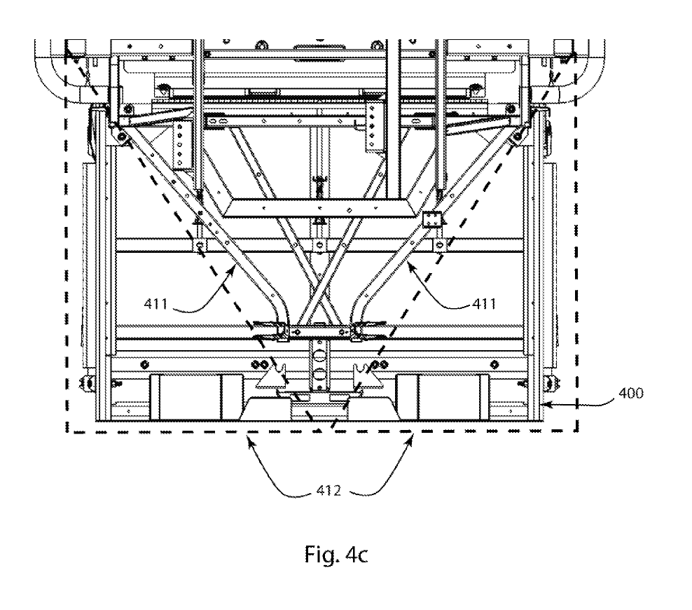

Referring now to FIG. 4a, base frame 400 provides the overall support structure for the flatbed system. Base frame 400 comprises four rails 401 arranged in a rectangular configuration defining the frame perimeter, said rails comprising one front rail and one rear rail, and one left side rail and one right side rail, wherein the ends of the front and rear rails join the ends of the left and right side rails at right angles, being bolted together, forming integral joints for a solid structure. At the front or forward portion of base frame 400, gussets 402 are provided at the corners forming junctions between the left and right side rails and the front rail, wherein said rails are bolted to gussets 402. Gussets 402 provide anchor points for attachment to the frame of the vehicle, as well as for the roll cage system of the vehicle to attach to the inventive flatbed system, providing structural support for trusses supporting cantilevered portions of the flatbed. The general shape of the outer frame is preferred to be rectangular, but is not by any means limited to this particular geometry. Persons skilled in the art will recognize that other shapes, such as triangular, are possible.

To reinforce the frame without significantly increasing weight, and to add additional structural support of docking or articulating components necessitating location within the interior of the frame, beams 403 are disposed within the open space of the frame interior, said beams running parallel to front and rear rails, and perpendicular to the left and right side rails, whereby the beams span the space between parallel rail pairs, forming bridges between parallel rails pairs, a first pair comprising the front and rear rails and a second pair comprising the left and right side rails. The bridging beams terminate and are integrally affixed to opposite members of the parallel rail pairs comprising the outer frame. Spring-loaded pins 404 are provided to hold hitch post brackets 405 against the center beam, manipulated by handles 404a. Hitch posts 406 thereby can readily be removed and attached as desired in the field. Hitch posts 406 and support bars 407 provide docking structures that mate with and secure removable seats (not shown). Countersunk rectangular regions 408 provide seats for placing tie-down rails, which are bolted to the frame via the threaded holes within the regions. Tie-down rails 409 are shown attached to the side rails.

In another aspect of the preferred embodiment of the inventive flatbed system shown in FIG. 4b, taillight wells 410 are attached on the bottom side of the rear rail of the outer frame. Wells 410 are intended to protect the taillights of the vehicle from undue stresses or from damage caused by loading or unloading personnel and/or cargo from the flatbed. The rear shield portion of the bed described above provides cutouts (see FIG. 3, 302) through which wells 410 protrude in the assembled inventive flatbed system. The shape of both the wells and cutouts are only exemplary and by no means intended to limit the possibility of shapes for these components of the inventive flatbed system. In general these are intended to be conform with the design of the vehicle taillights for the particular model of vehicle on which the flatbed system is installed.

FIG. 4c shows base frame 400 is bolted to points on the rear frame 411 of the ATV. The rear portion of ATV frames commonly have members that extend diagonally forming a triangular or A-frame structure, whereby the frame rails converge to a single point. Such a vehicular frame configuration forces the rear outward portions 412 of the inventive flatbed system to cantilever when significant loads are applied, such as when the inventive flatbed is employed to carry emergency litters.

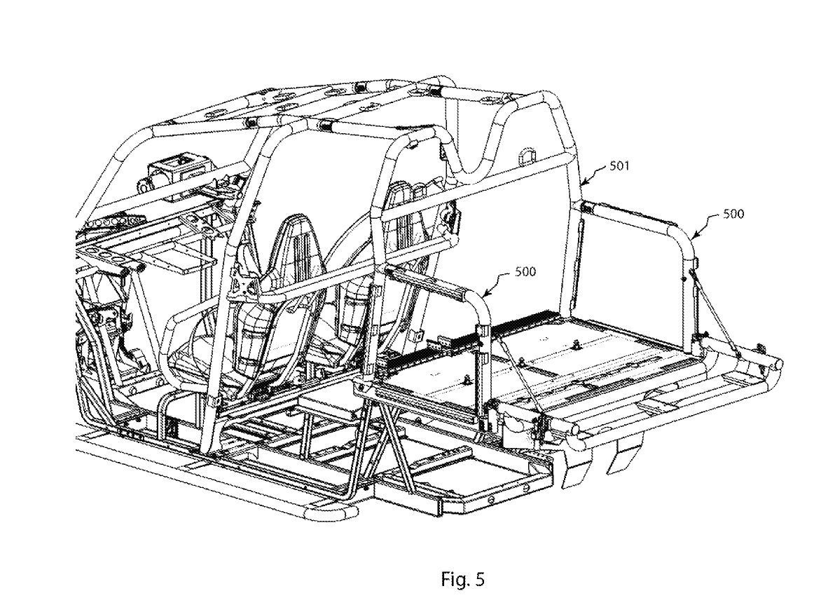

Referring to FIG. 5, the situation is remedied by judicious attachment of elements connecting the rear of the flatbed to structural members of the vehicle roll cage. Extra support of the rear outward portions of the rectangular base frame is accomplished by provision of support members 500 comprising rails that connect at one end to the side rails of base frame near the rear corners, and to a rear member 501 of the vehicle roll cage at the opposite end. In this way the load on the cantilevered portion the flatbed is transmitted to and partially supported by the vehicle frame.

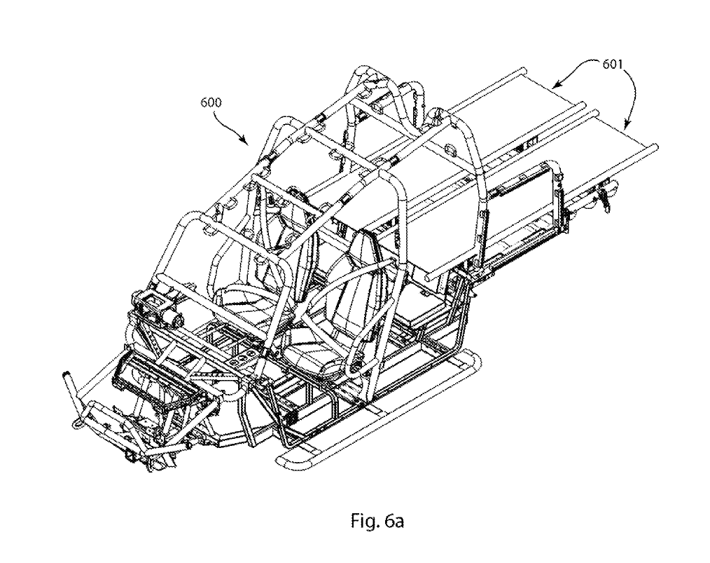

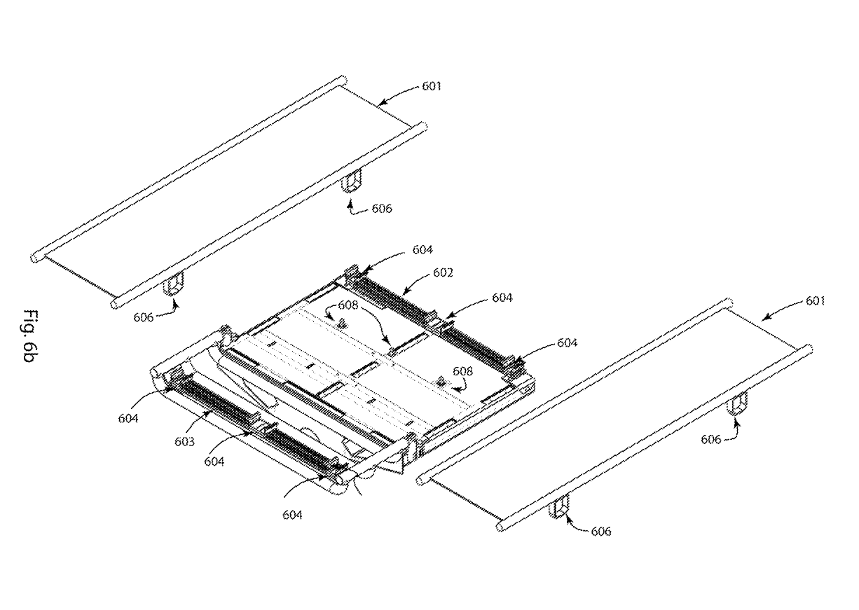

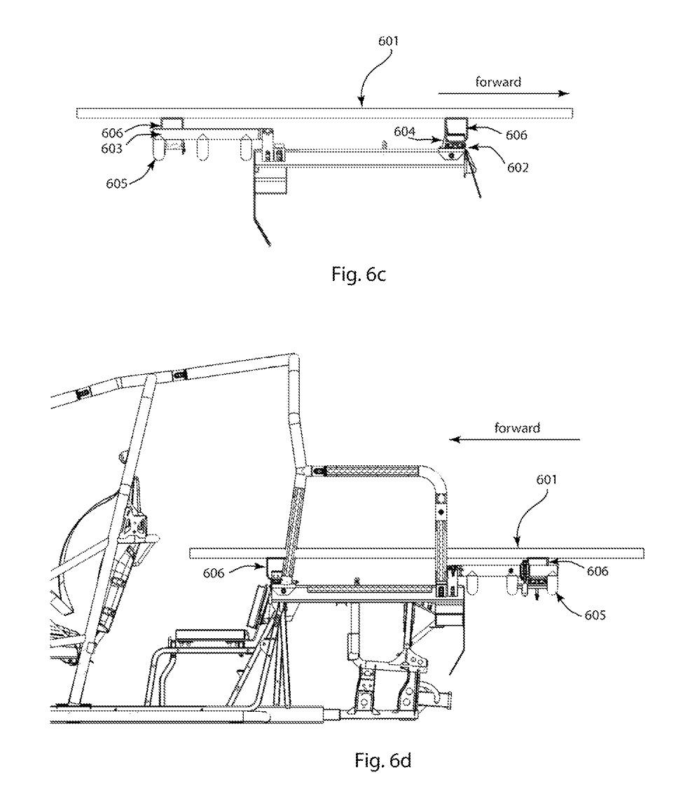

The preferred embodiment of the inventive flatbed system mounted on the LTATV frame superstructure 600 is designed to accommodate up to two emergency litters 601, shown in FIG. 6a. An exploded view of the preferred embodiment with the litters 601 lifted up and out in FIG. 6b, revealing the flatbed detail from the rear. To accommodate emergency litters, mounting means are disposed substantially in the most forward and aft portions of the flatbed. In the preferred embodiment, mounting means comprise track rails 602 and 603 with slideable catches 604 wherein a first track rail 602 is disposed at the front edge of the flatbed, whereby it is affixed to the front rail of the base frame, and a second track rail 603 is mounted on tailgate 605. Track rails 602 and 603 are provided with dovetailed grooves for sliding catches 604 that engage the mounting stirrups 606 of litters 601. Catches 604 can be freely positioned laterally by sliding them along the track rail to accommodate litters of arbitrary widths.

When tailgate 601 is in the open, folded down position, track rail 602 is collocated vertically with track rail 603, allowing litters 601 to be substantially horizontal with respect to the bed surface when their stirrups 606 have engaged litter catches 604 for mounting. This detail is shown in FIG. 6c, showing a side view of the inventive flatbed system with a litter mounted such that litter stirrups 606 are seated in catches 604, which are slideably engaged with track rails 602 and 603. FIG. 6d shows a side view of the rear portion of the LTATV, detailing the preferred embodiment litter mount configuration in relation to the vehicle.

Seats can be mounted on the inventive flatbed as well, where mounting hitch posts 608 (FIG. 6c) are provided and disposed near the fore portion of the flatbed. In the preferred embodiment, three hitches 608 are provided and disposed near the fore portion of the flatbed to accommodate Navy-type seats that can be readily mounted or removed by engaging the hitch or disengaging therefrom. Wells are disposed on the inventive flatbed in which the hitch post assemblies are secured.

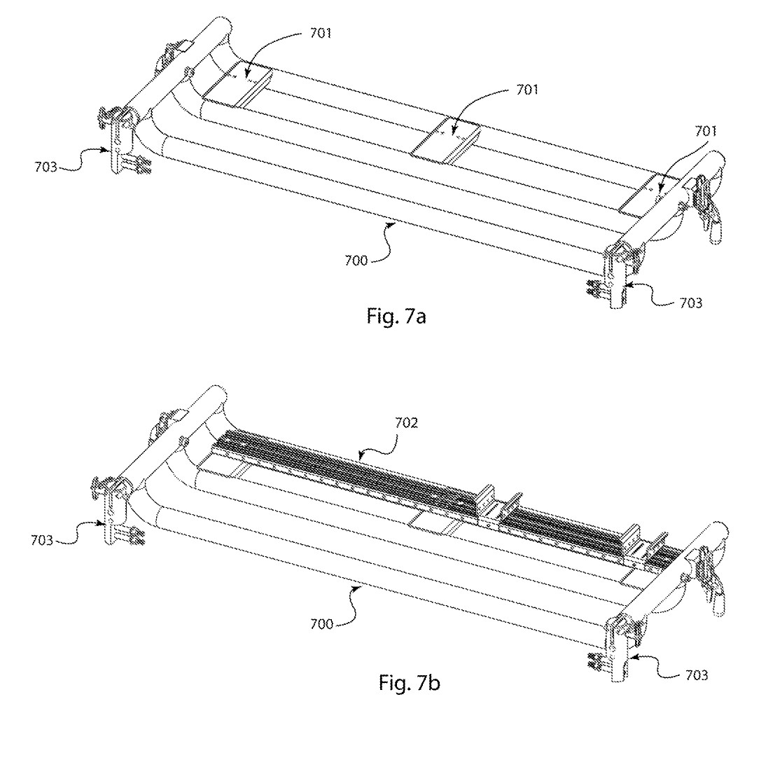

FIG. 7a shows more detail of the litter mount assembly on the tailgate 700. Mounting plates 701 are provided between the tailgate cross rails and welded thereto for the purpose of mounting track rail 702, as shown in FIG. 7b. Tailgate 700 is pivotally attached to the rear of the flatbed via hinge posts 703, which are in turn bolted to the rear portion of base frame side rails of the base frame.

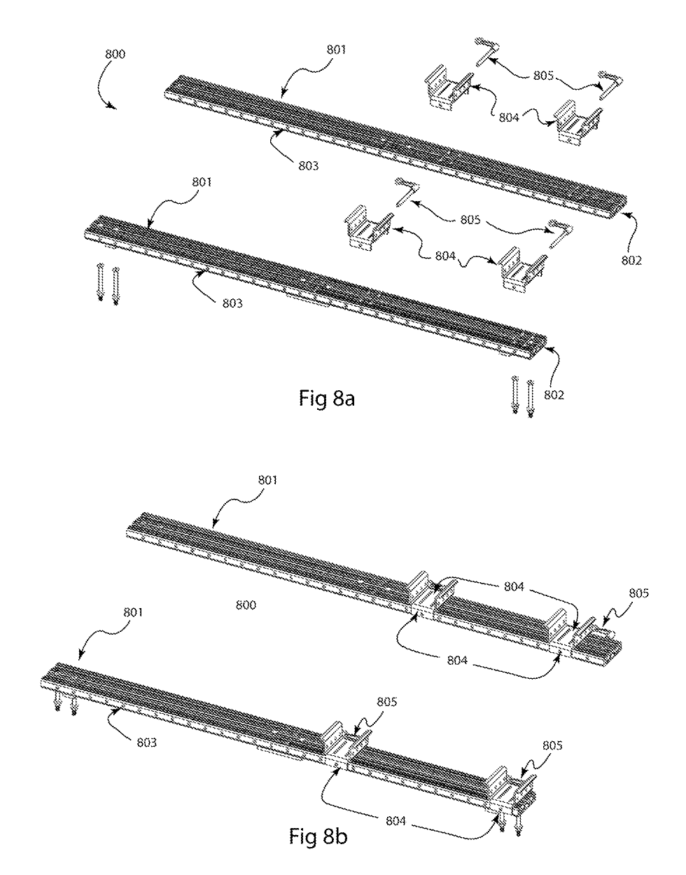

While NATO-style litters are widely used in by military medevac units, the inventive flatbed system is designed to accommodate non-standard stretchers and search-and-rescue litters as well. To this end, the litter mount assembly is adapted to readily adjust to the width of any type of litter, by the use of brackets sliding along a track. Referring to FIG. 8a showing an exploded view, the preferred embodiment of the inventive flatbed system comprises a litter mount assembly 800 that has been mentioned above (see FIGS. 2, 6 & 7), further comprising a pair of track rails 801 having a dovetail groove 802 and a plurality of holes 803 extending through the width of the rail. Both track rails each accommodate at least two litter catch brackets 804, the brackets being adapted to engage the surface of the track rail and freely slide along its length. When the desired position is reached, pins 805 lock brackets 804 in place by engaging through holes 803. FIG. 8b shows the assembly, with litter catch brackets 801 engaged and locked via pins 805 on the track rails 801.

The embodiment described herein is meant to be exemplary, and not intended to limit the scope and spirit of this invention. Those skilled in the art will recognize that equivalent structures fall within the scope and spirit of this invention, as described in the following claims.

1. A multifunctional flatbed system, comprising:
(i) A base frame affixed to a vehicle frame;
(ii) A substantially flat sheet forming the bed section juxtaposed over and affixed to the base frame;
(iii) A backing plate section hingeably attached to the forward portion of the bed section;
(iv) A heat shield section juxtaposed below and affixed to the base frame; and
(v) A tailgate section pivotably affixed to the aft edge of the bed section.

2. The bed section of claim 1, further comprising elongated slot perforations extending through the thickness of the bed section sheet and disposed substantially along the interior and the edges of the bed section.

3. The bed section of claim 2, wherein the slots are rectangular.

4. The bed section of claim 2, wherein the slots have rounded ends.

5. The bed section of claim 2, wherein the slots are square.

6. The bed section of claim 1, further comprising hitch posts for securing removable seats.

7. The bed section of claim 1, further comprising a rectangular dossier plate for supporting a rear seat dossier, wherein a first edge is hingeably attached to the edge of the forward portion of the bed section, said rectangular plate secured to the forward edge of the bed section by one or more hinges having the ability to rotate at least 300 degrees.

8. The rectangular plate of claim 7, wherein a rear seat pad support plate for supporting rear seat pads is attached to a second edge parallel to the first edge of the dossier support plate, said rear seat pad plate forming an obtuse angle with the dossier support plate.

9. The bed section of claim 1, further comprising a rear shield having a pre-formed sheet that is integral with the aft edge of the flat sheet, and substantially perpendicular to said flat sheet.

10. The rear shield of claim 9, wherein taillight cutouts are disposed on and penetrating through the preformed sheet.

11. The tailgate section of claim 1, further comprising two or more horizontal rails between which mounting plates are disposed for attaching aft track rails that slideably engage said litter catches, in such a way that when said tailgate is in the open position, the top surfaces of the aft track rails and the forward track rails are collocated vertically so that a litter engaged by the slidable catches is parallel to the bed plate surface.
